(19) United States
(12) Patent Application Publication
(10) Pub. No.: US 2010/0206898 A1
(43) Pub. Date: Aug. 19, 2010

(54) METHOD AND DEVICE FOR THE METERED DISPENSING OF A MEDIUM

(76) Inventor: Wilfried Santo, Loerrach-Hauingen (DE)

Correspondence Address: BACHMAN & LAPOINTE, P.C., 900 CHAPEL STREET, SUITE 1201, NEW HAVEN, CT, 06510, US

(21) Appl. No.: 12/679,943

(22) PCT Filed: Sep. 25, 2008
(86) PCT No.: PCT/EP08/08179

§ 371 Date: Mar. 25, 2010

(30) Foreign Application Priority Data
Sep. 25, 2007 (DE) 10 2007 045 964.7

(51) Int. Cl. G01F 11/06; B65D 35/22; B65D 35/30

(52) U.S. Cl. 222/1; 222/94; 222/287; 222/309

(57) ABSTRACT

A method for the metered dispensing of a medium from an opening (1) in a compressible container, particularly from a tube (2), wherein the medium is to reach a pre-chamber (21, 21.1) from the tube (2), wherein the volume of the pre-chamber is to be changed by moving a pressure element (8, 26, 29), wherein the medium is dispensed from an outlet opening (19, 19.1) by moving the pressure element (8, 26, 29).

### BACKGROUND OF THE INVENTION

The present invention relates to a method for the metered dispensing of a medium from an opening in a compressible container, particularly from a tube, and to a device for this purpose.

Different media are dispensed from a container in a wide variety of ways. For example, devices are known that work according to the suction pump principle. With a suitably sealed plunger, medium is sucked out of the container and, after closure of a nonreturn valve, is dispensed from an outlet opening. This is generally very imprecise and cannot be applied, for example, to tubes or the like.

The tubes presently available on the market for ointments, pastes, lotions, etc., are metered by the length of the dispensed ribbon of ointment. Particularly in the medical sector, the pack insert leaflet stipulates various ribbon lengths, which are estimated by feel or are measured off using a measurement rod during handling of the tube. This kind of procedure remains inaccurate and is not especially helpful in practice.

The problem addressed by the present invention is that of providing a method and a device of the abovementioned kind by means of which, for example, it is possible to comply precisely with a prescribed dose, and with which any desired products, irrespective of their viscosity, can be metered and dispensed.

### SUMMARY OF THE INVENTION

The problem is solved by the fact that the medium passes from the tube into a pre-chamber whose volume is changed by movement of a pressure element, and the medium is dispensed from an outlet opening by the movement of the pressure element.

This means that in this case, in contrast to the suction pump principle, the medium is not sucked out, but is instead actively pressed out of the tube into the pre-chamber by the user. In this way, the entire pre-chamber can be filled, such that calibration of the pressure element takes place by means of the latter being pressed back as far as an abutment. In this case, the user also knows that the entire pre-chamber is filled. When he now actuates this pressure element, he is therefore able to press a very precisely metered amount out of the outlet opening, for example a desired ribbon of ointment.

The pressure element can be designed in various ways. In one illustrative embodiment, it is conceivable for the pressure element to be designed as a linear plunger. In this case a ram, for example, is provided with a plunger face that seals against an inner wall of an axial channel. When this plunger face is acted upon by a medium, the linear plunger retreats and frees a space for receiving the medium. This space is of linear configuration.

In order to dispense the medium, pressure is applied to the linear plunger, such that the plunger face acts on the medium with pressure. The medium is pressed out through a separate outlet opening. Moreover, this outlet opening was closed by a suitable protective cap during the filling of the pre-chamber.

To permit precise metering, a suitable scale is provided on the linear plunger, in particular on the ram, and the housing in turn has a suitable marker. On the basis of the position of the scale relative to the marker, it is possible to read off precisely how much medium is dispensed.

In another illustrative embodiment of the invention, the pressure element is designed as a rotary ring with a slide which is moved in an annular chamber. This annular chamber communicates with the opening of the tube via at least one suitable transverse bore, such that, when pressure is applied to the tube, medium can pass through the transverse bore into the annular chamber. Pressure is also applied to the slide, such that the volume of the annular chamber is increased by rotating the rotary ring and the annular chamber is filled with medium. This preferably takes place between two abutments, which limit the rotation of the rotary ring.

This rotary ring is also provided with a scale, which permits a metered dispensing of the medium.

Moreover, a combination of linear movement and rotary movement of a corresponding pressure element also lies within the scope of the invention. In this case, for example, the pressure element can execute a helical movement.

It is of course conceivable for containers to be already provided with such a device according to the invention at the time of their production. However, it would probably be simpler to use the outer thread of the tubes, which is already present, in order to screw a device according to the invention onto a tube neck.

For tubes that cannot recover their shape, a nonreturn valve is not required in the device according to the invention. However, there are a large number of containers or tubes in which, when the medium is dispensed, medium may possibly be pressed back into the container by the pressure element. Here, of course, it is more advantageous to have a nonreturn valve. The latter can be made up of a single plastic cone, which is slit for the purpose of producing a valve outlet. However, it is also conceivable to use spring-loaded ball valves, injection-molded flap valves, plate valves, etc. In this respect, no limit is placed on the invention.

By virtue of the user-friendly handling according to the invention, the metering, particularly from tubes, is more reliable, and such tubes can be used in new fields of application. By employing medically approved materials, the system is of interest especially in the pharmaceutical market, for example for precise metering of pain-relief gels, ointments, skin-sensitive lotions, and aqueous products, etc., or also, for example, for mixing media in the dental sector.

### BRIEF DESCRIPTION OF THE DRAWINGS

Further advantages, features and details of the invention will become clear from the following description of preferred illustrative embodiments and from the drawing, in which:

FIG. 1 shows a longitudinal section through a device according to the invention for the metered dispensing of a medium, in the position of use on a pump, of which only part is shown;

FIG. 2 shows an enlarged detail from another illustrative embodiment of a device according to the invention for the metered dispensing of a medium, similar to FIG. 1;

FIG. 3 shows a longitudinal section through another illustrative embodiment of a device according to the invention for the metered dispensing of a medium from a tube, with only part of the tube being shown;

FIG. 4 shows a cross section through the device according to FIG. 3 along line IV-IV.

### DETAILED DESCRIPTION

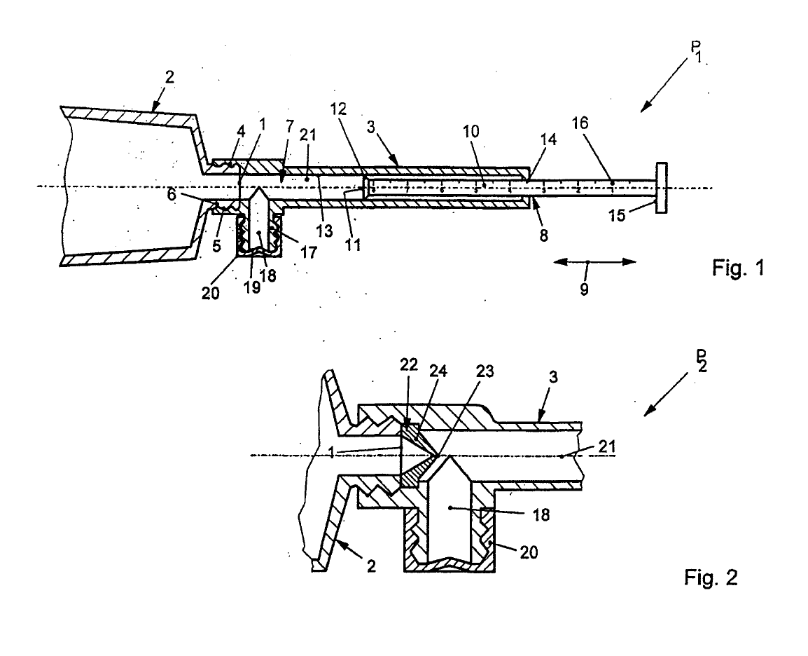

According to FIG. 1, a device P₁ according to the invention, for the metered dispensing of a medium from an opening 1 of an only partially depicted tube 2, has a housing 3 which is screwed via an inner thread 4 onto an outer thread 5 of a neck 6 of the tube 2. Passing through the housing 3 is an axial channel 7, in which a linear plunger 8 is arranged to be movable along the double arrow 9. A plunger face 11 is placed on a ram 10 of the linear plunger 8 inside the axial channel 7 and bears via an annular sealing lip 12 against an inner wall 13 of the axial channel 7. To further guide the linear plunger 8, the end of the housing 3 forms an annular opening 14, which encloses the ram 10. Outside the axial channel 7, i.e. after the annular opening 14, a pressure disk 15 is also fitted on the ram 10. A scale 16 can also be identified on the ram 10.

Near the neck 6, a nipple 17 is formed integrally on the housing 3 and has a radial bore 18 extending through it. This radial bore 18 leads to an outlet opening 19, which is closed by means of a protective cap 20 being screwed onto the nipple 17.

The function of the present invention is as follows:

The closure cap (not shown) of a tube 2, which contains an ointment for example, is unscrewed from the neck 6, and the device P₁ for the metered dispensing of the ointment from the tube 2 is screwed onto the neck 6. Ointment is now pressed out of the tube 2 through the opening 1 into the axial channel 7, with the linear plunger 8 retreating toward the right. In this way, a pre-chamber 21, of which the volume can be changed, is obtained in front of and in the radial bore 18 and in front of the outlet opening 19. The volume is initially increased by the ointment being pressed in from the tube 2 and by the retreat of the linear plunger 8.

If ointment is now to be dispensed in a metered amount from the outlet opening 19, the protective cap 20 is removed from the nipple 17. Thereafter, pressure is applied to the linear plunger 8 by pressing on the pressure disk 15, such that the plunger face 11 reduces the volume of the pre-chamber 21. In this way, ointment is pressed through the radial bore 18 and out of the outlet opening, and the scale 16 allows the amount dispensed to be precisely monitored.

The annular opening 14 serves as an abutment for the plunger face 11 and also for the pressure disk 15. The movement of the linear plunger 8 is limited in this way.

In the case of metal tubes, for example aluminum tubes, or tubes made of similar materials, i.e. tubes or containers which, after being squeezed or pressed, remain in the squeezed position, that is to say do not return to the original shape, the medium in the tube itself constitutes a barrier against return flow.

In tubes with a return suction or return flow effect, for example in plastic tubes with their own restoring force of the tube wall, it would probably be advisable, however, to fit a nonreturn valve 22 as indicated in FIG. 2. Such a valve is preferably made of a soft material, e.g. LLDPE, in order to utilize the residual stress of the material of the valve wall thickness as closure force. For a valve outlet 23, a conical valve wall 24 is slit in order thereby to permit opening and closing. To reliably maintain the metering function, this nonreturn valve 22 is preferably placed between the opening 1 and the radial bore 18.

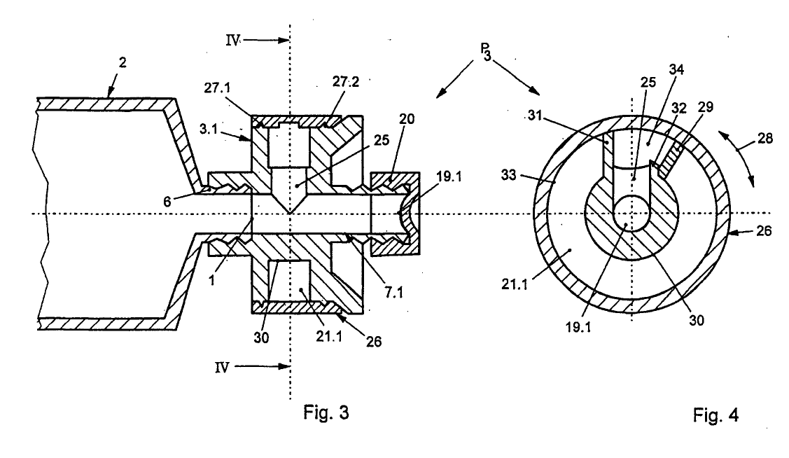

In the further illustrative embodiment of a device P₃ according to the invention for the metered dispensing of a medium from a tube 2 according to FIGS. 3 and 4, a housing 3.1 is likewise screwed onto the tube neck 6. This housing 3.1 also has an axial channel 7.1 running through it, but in this case the axial channel 7.1 extends axially from the opening 1 as far as an outlet opening 19.1. This outlet opening 19.1 is again closed by the protective cap 20.

In this illustrative embodiment, a pre-chamber 21.1 is not part of the axial channel, but is designed as a separate annular chamber that encircles the axial channel 7.1 and communicates with the latter via at least one transverse bore 25.

The pre-chamber 21.1 is closed off from the outside by a rotary ring 26, and this rotary ring 26, together with corresponding housing walls, forms at least two annular seals 27.1 and 27.2.

According to FIG. 4, the rotary ring 26, which can be rotated according to the double arrow 28, is assigned a slide 29, which extends more or less radially away from the rotary ring 26 and bears on an annular wall 30 of the housing 3.1.

In cooperation with the slide 29, the rotation movement of the rotary ring 26 is delimited by two abutments 31 and 32, which protrude from the annular wall 30 near the transverse bore 25. The abutment 21 reaches as far as an inner wall 33 of the rotary ring 26, while the other abutment 32 engages only a short distance into the rotation path of the slide 29, such that the latter cannot travel past this abutment 32. However, toward the inner wall 33 of the rotary ring 26, it leaves free a through-flow opening 34 through which medium can flow and exert pressure on the slide 26, such that here too a pre-chamber 21.1 of variable volume is obtained.

Here too, there is a scale (not shown) present on the outside of the rotary ring 26, which scale can interact for example with a marker (not shown) on the housing 3.1.

The function of this illustrative embodiment of a device P₃ according to the invention is similar to that according to FIG. 1. However, the pre-chamber does not fill linearly, but circularly. In other words, the medium that is to be dispensed is pressed out of the tube 2 and, with the outlet opening 19.1 closed, passes through the transverse bore 25 into the pre-chamber 21.1. There, this medium presses on the slide 29, such that the rotary ring 26 is rotated, until the slide 29 reaches the abutment 31.

To dispense the medium, the protective cap 20 is again removed from the outlet opening 29.1. The rotary ring 26 is then rotated counter to the filling direction, such that pressure is exerted by the slide 29 on the medium in the pre-chamber 21.1. This medium flows through the through-flow opening 34, the transverse bore 25 and the axial channel 7.1 and out of the outlet opening 19.1.

When the term compressible is used elsewhere in this text, it is not to be understood as referring only to a container whose own wall is deformable, and instead it also includes the known two-chamber cans with a squeezable inner pouch. It also includes containers which have a rigid wall but whose volume can be modified by plungers, membranes or the like. It is important only that the medium can be dispensed actively from the container by an action of the user.

1-23. (canceled)

24. A method for the metered dispensing of a medium from an opening in a compressible container, particularly from a tube, wherein the medium passes from the tube into a pre-chamber, the method comprises changing the volume of the pre-chamber by movement of a pressure element, wherein the medium is dispensed from an outlet opening by the movement of the pressure element.

25. The method as claimed in claim 24, wherein the container is compressed in order to introduce the medium into the pre-chamber.

26. The method as claimed in claim 24, wherein the outlet opening is closed during the introduction of the medium into the pre-chamber.

27. The method as claimed in claim 24, wherein the pressure element for dispensing the medium from the pre-chamber is moved linearly.

28. The method as claimed in claim 24, wherein the pressure element for dispensing the medium from the pre-chamber is rotated.

29. A device for the metered dispensing of a medium comprising a compressible container having an opening, wherein the opening of the compressible container is assigned a pre-chamber in a housing, a pressure element for changing the volume of the pre-chamber, and an outlet opening leading from the pre-chamber.

30. The device as claimed in claim 29, wherein the outlet opening is closed with a protective cap.

31. The device as claimed in claim 29, wherein a linear plunger is arranged in the pre-chamber.

32. The device as claimed in claim 31, wherein a plunger face is provided on the linear plunger toward the pre-chamber.

33. The device as claimed in claim 32, wherein the plunger face bears via at least one sealing lip against an inner wall of the pre-chamber.

34. The device as claimed in claim 31, wherein a scale is provided on the linear plunger.

35. The device as claimed in claim 29, wherein the pre-chamber is designed as an annular chamber.

36. The device as claimed in claim 35, wherein the annular chamber communicates with the opening from the container via an inlet.

37. The device as claimed in claim 35, wherein the annular chamber is closed from the outside by a rotary ring.

38. The device as claimed in claim 37, wherein a slide protrudes more or less radially into the pre-chamber from the rotary ring.

39. The device as claimed in claim 38, wherein the slide is assigned two abutments in the pre-chamber.

40. The device as claimed in claim 39, wherein an abutment is provided respectively on one side of the inlet.

41. The device as claimed in claim 40, wherein one abutment reaches as far as the rotary ring, while the other abutment leaves free a through-flow opening to the pre-chamber.

42. The device as claimed in claim 37, wherein the rotary ring has a scale.

43. The device as claimed in claim 29, wherein the housing is screwed with a thread onto a neck of the container, said neck encircling the opening.

44. The device as claimed in claim 29, wherein the opening from the container is assigned a nonreturn valve.
